(19) United States
(12) Patent Application Publication
(10) Pub. No.: US 2004/0083357 A1
(43) Pub. Date: Apr. 29, 2004

(54) Method, system, and program for executing a boot routine on a computer system

(75) Inventors: William L. Duncan, Berthoud, CO (US); John G. Kennedy, Longmont, CO (US)

Correspondence Address: KONRAD RAYNES VICTOR & MANN LLP, Suite 210, 315 S. Beverly Drive, Beverly Hills, CA, 90212, US

(73) Assignee: Sun Microsystems, Inc.

(21) Appl. No.: 10/283,637

(22) Filed: Oct. 29, 2002

(51) Int. Cl. G06F 9/445

(52) U.S. Cl. 713/2

(57) ABSTRACT

Provided are a method, system, and program for operating a computer system, wherein the computer includes at least two storage units. A boot routine from an operating system on a first storage unit of the at least two storage units designated as the primary storage unit is executed. A second storage unit of the at least two storage units comprises a spare storage unit, wherein both the storage units maintain copies of the operating system and file system in the computer. If the boot routine does not succeed, then the second storage unit is designated as the primary storage unit, wherein the first storage unit is the spare storage unit after the second storage unit is designated as the primary storage unit. After designating the second storage unit as the primary storage unit, the boot routine is executed from an operating system on the second storage unit designated as the primary storage unit.

### BACKGROUND OF THE INVENTION

1. Field of the Invention

The present invention relates to a method, system, and program for executing a boot routine on a computer system.

2. Description of the Related Art

High availability systems are computer systems that must include the capability to remain available even in the event of a failure within the system. For instance, server computers that operate as a storage subsystem to provide access to critical data, may include redundant hardware components that may be used in the event of a hardware failure. When a failure occurs, the system would perform a failover operation to switch to using the available redundant hardware component. Such hardware redundancy is often included in higher-end enterprise storage sub-systems and servers. However, in certain environments, one or more low end or less expensive servers may be deployed in a network environment that still requires high availability. Further, hardware developers may want to improve the availability of their mid to lower end systems to increase their desirability to consumers.

For these reasons, there is a need in the art to provide additional techniques for improving the availability of computer systems.

### SUMMARY OF THE DESCRIBED IMPLEMENTATIONS

Provided are a method, system, and program for operating a computer system, wherein the computer includes at least two storage units. A boot routine from an operating system on a first storage unit of the at least two storage units designated as the primary storage unit is executed. A second storage unit of the at least two storage units comprises a spare storage unit, wherein both the storage units maintain copies of the operating system and file system in the computer. If the boot routine does not succeed, then the second storage unit is designated as the primary storage unit, wherein the first storage unit is the spare storage unit after the second storage unit is designated as the primary storage unit. After designating the second storage unit as the primary storage unit, the boot routine is executed from an operating system on the second storage unit designated as the primary storage unit.

In further implementations, a check operation is performed on the spare storage unit and if the check operation fails, then the operating system and file system on the storage unit designated as the primary storage unit are copied to the spare storage unit.

Still further, an upgrade may be applied to the operating system on the primary storage unit. In such case, data on the second storage unit is deleted as part of the upgrade to the operating system and the boot routine is executed after applying the upgrade. The operating system and file system on the storage unit designated as the primary storage unit are copied to the spare storage unit during the boot routine executed after applying the upgrade.

In further implementations, no user data is maintained on the two storage unit drives.

Still further, designating one storage unit as the primary storage unit is performed by updating a parameter in a boot device in the computer.

Described implementations provide techniques for maintaining an operating system on two different storage units associated with a computer system to allow the system to boot from either of the storage units, thereby increasing the availability of the computer system.

### BRIEF DESCRIPTION OF THE DRAWINGS

Referring now to the drawings in which like reference numbers represent corresponding parts throughout:

FIG. 1 illustrates a computing environment in accordance with implementations of the invention;

FIG. 2 illustrates logic to perform a boot routine in accordance with implementations of the invention;

FIG. 3 illustrates a network computing environment in which aspects of the invention may be implemented; and

FIG. 4 illustrates an architecture of computing components in the network environment, such as the hosts and storage controller, and any other computing devices.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

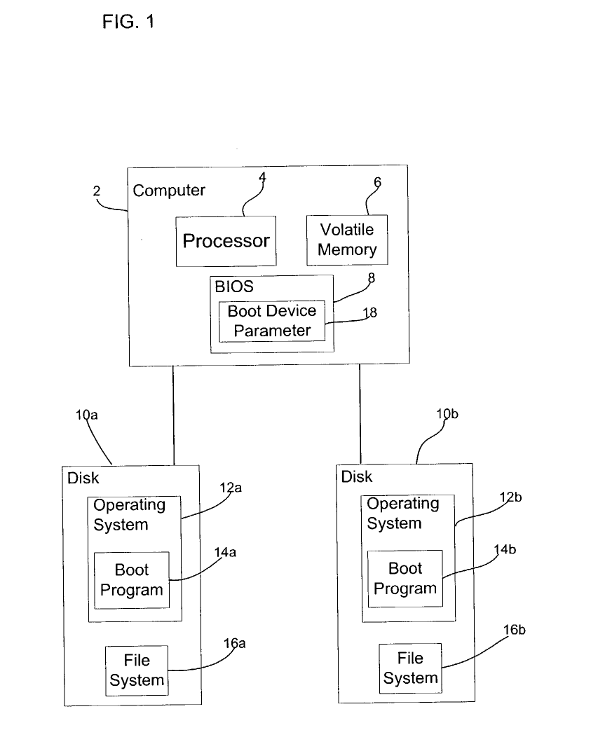

FIG. 1 illustrates a computing environment in which aspects of the invention are implemented. A computer 2 has a processor 4 and volatile memory 6 in which programs are loaded for execution. The computer 2 includes a Basic Input Output System (BIOS) 8 integrated circuit, which includes code to perform the boot sequence to start the computer 2, among other operations. The computer 2 has two attached hard disk drives 10a, 10b, which may be inside the computer 2 enclosure and connected to a computer 2 bus (not shown) in a manner known in the art. Alternatively, the hard disk drives 10a, 10b may be located external to the computer 2 and connected to an external communication port on the computer, such as a Universal Serial Bus (USB) port, FireWire port, parallel port, serial port, etc. Each hard disk drive 10a, 10b may maintain a copy of an operating system 12a, 12b, which the processor 4 loads into memory 6 to run. Each operating system 12a, 12b includes a boot program 14a, 14b, which performs boot related operations described herein. The hard disk drives 10a, 10b further include file systems 16a, 16b. The BIOS 8 includes a boot device parameter 18, which indicates the boot disk drive 10a, 10b from which the operating system 12a, 12b will be loaded. The BIOS 8 would include additional parameters used during the boot process that are known in the art.

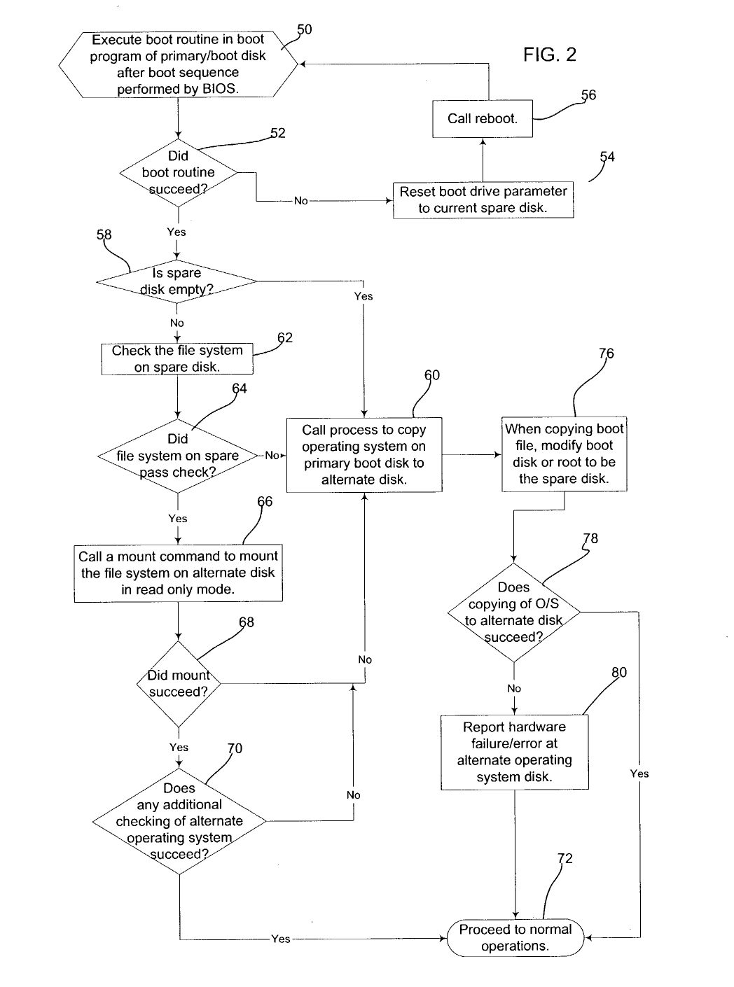

In certain implementations, the code of the boot program 14a, 14b, whose execution is described below with respect to FIG. 2, may comprise a script program that is part of the operating system 12a, 12b, such as shown in FIG. 1. Alternatively, the boot program 14a, 14b may be implemented as firmware in the BIOS 8. Still further, the code or operations described with respect to the boot program 14a, 14b may be implemented in both the BIOS 8 and program files that are part of the operating system 12a, 12b on each disk 10a, 10b.

The computer 2 may comprise any computing device known in the art, such as a server class machine, personal computer, laptop, handheld computing device, Internet appliance, virtualization device, telephony device, workstation, storage host, etc. The hard disk drives 10a, 10b may comprise any non-volatile storage device known in the art from which a processor 4 can boot. The hard disk drives 10a, 10b may comprise magnetic disk drives, such as disks that may be readily removed from the computer, e.g., such as hot swappable disks. In alternative implementations, any non-volatile storage unit known in the art may be used in place of hard disk drives. The operating system 12a, 12b may comprise any operating system known in the art, such as a Unix® (Unix is a registered trademark of the Open Group) based operating system (e.g., the Sun Microsystem, Inc. Solaris® operating system; Sun and Solaris are registered trademarks of Sun Microsystems Inc.), a Microsoft Windows® (Microsoft and Windows are registered trademarks of Microsoft Corporation), Linux® (Linux is a registered trademark of Linus Torvalds), a Real Time Operating System (RTOS) or other device specific operating system, etc. The BIOS 8 may comprise any boot device known in the art that includes code to perform the initial boot sequence, such as the boot Programmable Read Only Memory (PROM) including OpenBoot firmware that is installed on workstations manufactured by Sun Microsystems, Inc.

In certain implementations, the computer 2 includes two hard disk drives 10a, 10b, each maintaining a copy of the operating system 12a, 12b so that in the event one disk drive fails during a boot operation, the processor 4 may boot from the copy of the operating system maintained on the spare disk drive. This ensures high availability for the computer 2 because in the event that one disk fails, the computer 2 may still reboot from the spare disk.

FIG. 2 illustrates logic implemented in the boot program 14a, 14b that may be loaded from either disk 10a, 10b designated as the primary disk in the boot device parameter 18, or some other location. Alternatively, as discussed, certain operations described in FIG. 2 may be performed by the BIOS 8. Control begins at block 50 with the processor 4 executing the boot program 14a, 14b from the disk determined to be the primary disk, which in this description will comprise disk 10a, although either disk 10a, 10b may be determined to be the primary boot disk. The primary boot disk may be identified as the boot disk in the boot device parameter 18 of the BIOS 8 as shown in FIG. 1. In alternative implementations, alternative techniques known in the art other than a parameter 18 in the BIOS 8 may be used to determine the primary disk 10a from which to boot. The code of the boot program 14a, 14b may be executed after the BIOS 8 executes the system boot sequence to initialize the hardware components, which may include a power-on self test (POST), initialization of hardware devices, such as a video card, disks, input devices, memory tests, etc. For instance, the code of the boot program 14a, 14b may be executed after the BIOS 8 initialization operations and before the logon screen is displayed. If (at block 52) execution of the boot routine in the boot program 14a fails, then the processor 4 resets (at block 54) the boot device parameter 18 in BIOS 8 to the spare disk 10b so that the processor 4 next boots from the disk currently functioning as the spare disk 10b. In certain implementations, the resetting operation may be performed by initializing code to execute during the next boot operation to change the boot device parameter 18 during the next boot operation. Alternatively, the resetting operation may comprise flashing the BIOS 8 to change the parameter 18. After resetting the boot disk, the processor 4 then initiates (at block 56) a boot operation to reboot the system, with the boot device parameter 18 being set to the spare disk 10b.

If (at block 52) the boot routine succeeds, then the processor 2 checks (at block 58) whether the spare disk 10b is empty. The spare disk 10b may be empty on the first boot after a new spare disk 10b is added. If the spare disk 10b is empty, then the processor 4 calls (at block 60) a process to copy the entire content of the primary disk 10a, including the operating system 12a and file system 16a, to the spare disk 10b as operating system 12b and file system 16b. This copy operation may modify certain operating system 12b files that reference the boot disk to make the spare disk 10b the root disk or directory. From block 58, if the spare 10b already has a copy of the operating system, then the processor 4 checks (at block 62) whether the file system 16b on the alternate disk 10b is valid. In certain implementations, the processor 2 may validate the file system 16b on the alternate disk 10b by calling an operating system check facility used to check for inconsistencies, such as the “fsck” facility used in the Unix® operating system environment or the “chkdsk” and “autochk” file system checking facilities used in the Microsoft Windows® operating system environment. If the file system (at block 64) passes the check, i.e., the checking operation did not locate any unacceptable inconsistencies in the alternate file system 16b, then the processor 4 would attempt to mount (at block 66) the file system 16b on the spare disk 10b in read only mode to check whether the copy of the operating system 12b and file system 16b on the spare disk 10b are mountable and accessible, to ensure that the spare disk 10b will be accessible in the event of a failure of the current primary disk 10a. In further implementations, the file system check operation may attempt to repair any located inconsistencies. In such implementations, the check operation at block 62 would fail only if the check operation could not repair the file inconsistencies. If (at block 68) the mount succeeded, then the processor 4 may perform (at block 70) any additional checking of the files and data on the spare disk 10b, such as verifying the accessibility and/or content of certain operating system 12b or other files or records. If such additional checking passes, then control proceeds to block 72 where the boot program 14a terminates and normal computer operations continue until a reboot or boot event occurs.

If (at block 64) the file system 16b did not pass the check operation or the mount failed (at block 68) or any additional checking failed (at block 70), then the processor 4, executing the boot program 14a calls (at block 60) a process to copy the content or image of the primary disk 10a, including the operating system 12a, boot program 14a, and file system 16a to the spare disk 10b. When performing the copy operation, the processor 4 may modify (at block 76) certain files in the operating system 12b to identify the current spare disk 10b as the primary or root disk to allow the current spare disk 10b to function as the primary disk in the event that a boot on the primary disk 10a fails and the subsequent boot occurs from the current spare disk 10b. If (at block 78) the copying process succeeded, then control proceeds to block 72 for normal computer operations. In certain implementations, the copy process may be performed as a background operation at the computer 2 so that user access to the computer 2 resources may be permitted during such background copy operation. If (at block 78) the copy operation failed, then an error message is reported (at block 80) to the computer 2 to notify an administrator or a user of the error. This error message may indicate a hardware failure because failure of the copy operation, along with one of the other tests at block 64, 68, and 70 may indicate that the problem with the spare disk 10b is hardware related. The reported error message may further indicate the result of the file system check (at block 64), e.g., fscsk, the attempt to mount the file system 14b on the spare disk 10b(at block 68) and the additional checking (at block 70). The error message may also prompt the user to swap out the spare disk 10b for a new spare.

During the initial setup of the computer 2, an administrator or user may install the operating system 10a, including the boot program 14a, on a primary disk 10a and install an empty formatted spare disk 10b. During the very first boot operation, the content of the primary disk would be copied to the spare disk 10b at block 60. Further, the initial copy operation at block 60 would be performed if the user installs a new empty spare disk 10b into the computer 2 after being notified of a failure of the spare disk through an error message generated at block 80.

In certain implementations, user data may not be maintained on the disks 10a, 10b, such that disks 10a, 10b only maintain operating system and other files needed for the computer 2 to operate. In such case, the user data may be on an additional disk drive within the computer 2, or on a data partition on one or both of the disks 10a, 10b. If the computer 2 is functioning as a server, then the data may be stored in a remote storage device or local disk drive system. In further implementations, the disks 10a, 10b may maintain application programs, so that the full functionality of the computer system 2, as embodied in operating system files and application program files, may run in full from either of the disks 10a, 10b.

In certain implementations, the described dual disk system may be used to provide high availability for a standalone server in a network with one or more attached clients, for a single workstation or computer or for a network of servers and clients. Yet further, the computer system 2 may be deployed as a standalone workstation or personal computer. Personal computer user's may be interested in a computer system 2 having the described dual disk system for high availability because the added protection of the spare may be provided at the cost of an extra disk drive, which is continually decreasing.

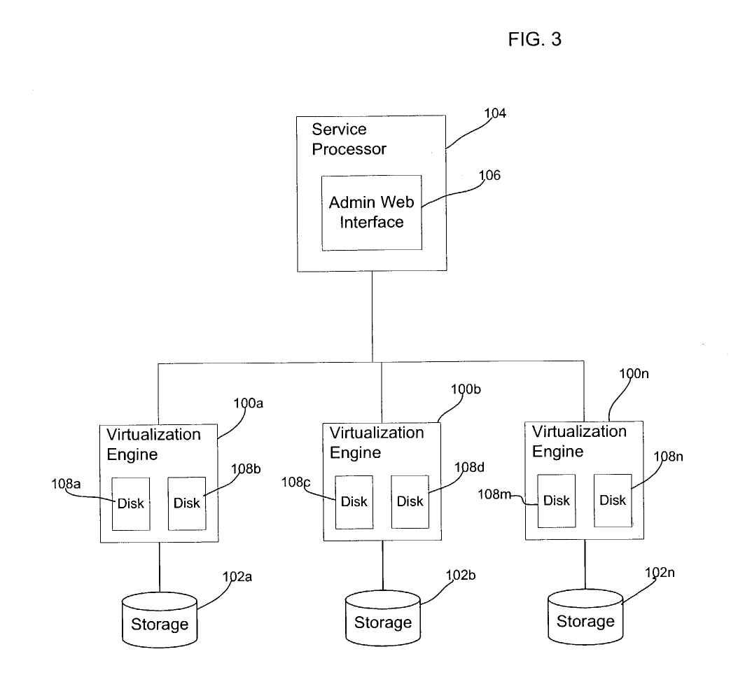

FIG. 3 illustrates a network implementation where a plurality of virtualization engine computers 100a, 100b . . . 100n provide access to attached data storage 102a, 102b . . . 102n, respectively. A service processor system 104 manages the virtualization engines 100a, 100b . . . 100n and provides a view of the data in all the storages 102a, 102b . . . 102n as a single storage space. The service processor 104 includes an administrator web interface 106 through which an administrator may access management programs in the service processor 104 that are used to manage and configure the virtualization engines 100a, 100b . . . 10n and their attached storage 102a, 102b . . . 102n. In the implementation of FIG. 3, each virtualization engine 100a, 100b . . . 100n includes two disks 108a, 108b . . . 108n, wherein each virtualization engine 100a, 100b . . . 10n may boot from either disk in the manner described above with respect to FIGS. 1 and 2. With the described network implementation, relatively less expensive server machines may be used as the virtualization engines 100a, 100b . . . 100n because high availability is provided by using the dual disk invention described above within the virtualization engines 100a, 100b . . . 100n. In certain implementations, the virtualization engines 100a, 100b . . . 100n would not store user data as such data is maintained in the storage systems 102a, 102b . . . 102n.

### Additional Implementation Details

The described techniques for booting a computer system may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the present invention, and that the article of manufacture may comprise any information bearing medium known in the art.

In certain described implementations, the system manages one disk as a primary and the other as a spare. In alternative systems, the primary may comprise one partition and the swap component may comprise another partition on the same disk.

In the described implementations, after the boot routine succeeds, various check operations are performed on the spare disk, such as a file system verification check, a mount operation check, and other file checking operations. In alternative implementations, any disk or file check operation known in the art may be performed with respect to the spare disk to determine whether the copy of the operating system and file system on the spare disk, as well as any application programs, are functional in order to ascertain whether the content of the primary disk should be mirrored or copied to the spare disk.

Any upgrades to the operating system files may include code to delete the content of the spare disk when performing the operating system upgrade in order to cause the boot program to copy the content of the primary disk including the upgraded operating system to the spare disk w during the next boot operation. In this way, the operating system upgrade gets applied to the spare disk.

The illustrated logic of FIG. 2 shows certain events occurring in a certain order. In alternative implementations, certain of the described operations may be performed in a different order, modified or removed. Morever, steps may be added to the above described logic and still conform to the described implementations. Further, operations described herein may occur sequentially or certain operations may be processed in parallel. Yet further, operations may be performed by a single processing unit or by distributed processing units.

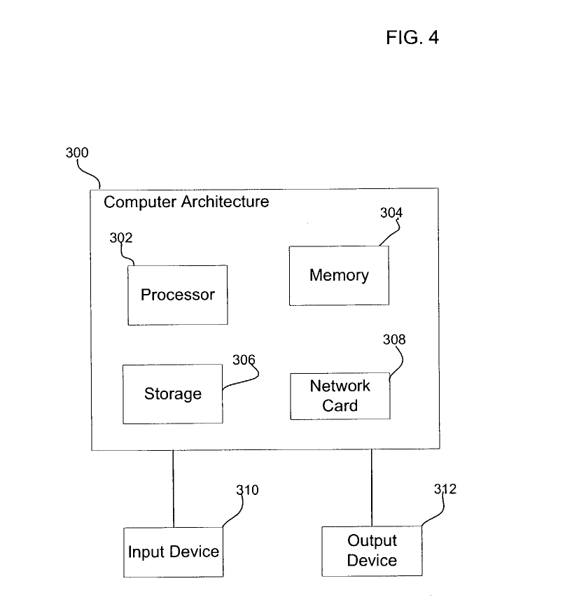

FIG. 4 illustrates one implementation of a computer architecture 300 of the components and systems shown in FIGS. 1 and 3. The architecture 300 may include a processor 302 (e.g., a microprocessor), a memory 304 (e.g., a volatile memory device), and storage 306 (e.g., a non-volatile storage, such as magnetic disk drives, optical disk drives, a tape drive, etc.). The storage 306 may comprise an internal storage device or an attached or network accessible storage. Programs in the storage 306 are loaded into the memory 304 and executed by the processor 302 in a manner known in the art. The architecture further includes a network card 308 to enable communication with a network. An input device 310 is used to provide user input to the processor 302, and may include a keyboard, mouse, pen-stylus, microphone, touch sensitive display screen, or any other activation or input mechanism known in the art. An output device 312 is capable of rendering information transmitted from the processor 302, or other component, such as a display monitor, printer, storage, etc.

The foregoing description of various implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

What is claimed is:

1. A computer implemented method for operating a computer system, wherein the computer includes at least two storage units, comprising:
executing a boot routine from an operating system on a first storage unit of the at least two storage units designated as the primary storage unit, wherein a second storage unit of the at least two storage units comprises a spare storage unit, and wherein both the storage units maintain copies of the operating system and file system in the computer;
if the boot routine does not succeed, designating the second storage unit as the primary storage unit, wherein the first storage unit is the spare storage unit after the second storage unit is designated as the primary storage unit; and
after designating the second storage unit as the primary storage unit, executing the boot routine from an operating system on the second storage unit designated as the primary storage unit.

2. The method of claim 1, further comprising:
performing a check operation on the spare storage unit; and
if the check operation fails, then copying the operating system and file system on the storage unit designated as the primary storage unit to the spare storage unit.

3. The method of claim 2, wherein the check operation comprises checking the file system on the spare storage unit for inconsistencies.

4. The method of claim 2, wherein the check operation comprises a series of check operations, wherein the copy operation is performed if one of the check operations fails.

5. The method of claim 4, wherein a first check operation comprises checking the file system on the spare storage unit for inconsistencies and wherein a second check operation comprises mounting the file system on the spare storage unit.

6. The method of claim 2, further comprising:
if the copy operation fails, transmitting an error message indicating an error on the spare storage unit.

7. The method of claim 2, wherein performing the copying operation comprises mirroring the primary storage unit to the spare storage unit.

8. The method of claim 7, further comprising:
modifying on the spare storage unit at least one of the files copied from the primary storage unit to the spare storage unit to indicate the file system on the spare storage unit.

9. The method of claim 1, further comprising:
determining whether the spare storage unit includes a copy of the operating system; and
if the spare storage unit does not include the copy of the operating system, then copying the operating system and file system on the storage unit designated as the primary storage unit to the spare storage unit.

10. The method of claim 9, wherein determining whether the spare storage unit does not include the operating system comprises determining whether the spare storage unit is empty.

11. The method of claim 1, further comprising:
applying an upgrade to the operating system on the primary storage unit;
deleting data on the second storage unit as part of the upgrade to the operating system;
executing the boot routine after applying the upgrade; and
copying the operating system and file system on the storage unit designated as the primary storage unit to the spare storage unit during the boot routine executed after applying the upgrade.

12. The method of claim 1, wherein the storage units comprise magnetic hard disk drives.

13. The method of claim 1, wherein the storage units comprise separate partitions of a single hard disk drive.

14. The method of claim 1, wherein no user data is maintained on the two storage unit drives.

15 The method of claim 1, wherein the computer comprises a server managing access to storage, wherein a plurality of client computers access the storage through the server.

16. The method of claim 1, wherein designating one storage unit as the primary storage unit is performed by updating a parameter in a boot device in the computer.

17. A computer comprising:
a first and second storage units;
means for executing a boot routine from an operating system on the first storage unit designated as the primary storage unit, wherein the second storage unit comprises a spare storage unit, and wherein both the storage-units maintain copies of the operating system and file system in the computer;
means for designating the second storage unit as the primary storage unit if the boot routine does not succeed, wherein the first storage unit is the spare storage unit after the second storage unit is designated as the primary storage unit; and
means for executing the boot routine from an operating system on the second storage unit designated as the primary storage unit after designating the second storage unit as the primary storage unit.

18. The system of claim 17, further comprising:
means for performing a check operation on the spare storage unit; and
means for copying the operating system and file system on the storage unit designated as the primary storage unit to the spare storage unit if the check operation fails.

19. The system of claim 17, further comprising:
means for modifying on the spare storage unit at least one of the files copied from the primary storage unit to the spare storage unit to indicate the file system on the spare storage unit.

20. The system of claim 17, further comprising:
means for determining whether the spare storage unit includes a copy of the operating system; and
means for copying the operating system and file system on the storage unit designated as the primary storage unit to the spare storage unit if the spare storage unit does not include the copy of the operating system.

21. The system of claim 17, further comprising:
means for applying an upgrade to the operating system on the primary storage unit;
means for deleting data on the second storage unit as part of the upgrade to the operating system;
means for executing the boot routine after applying the upgrade; and
means for copying the operating system and file system on the storage unit designated as the primary storage unit to the spare storage unit during the boot routine executed after applying the upgrade.

22. The system of claim 17, wherein no user data is maintained on the two storage units.

23. The system of claim 17, further comprising:
a boot device, wherein the means for designating one storage unit as the primary storage unit updates a parameter in the boot device in the computer.

24. A network system capable of receiving data requests from host systems, comprising:
a network
a plurality of storage systems, wherein the host data requests are directed to data on the storage systems;
a plurality of servers attached the network, wherein the servers are capable of receiving data requests from hosts over the network, wherein each storage system is coupled to one server, and wherein the servers execute host I/O requests against the storage systems attached to the servers, wherein each server includes:
(i) a first and second storage units;
(ii) means for executing a boot routine from an operating system on the first storage unit designated as the primary storage unit, wherein the second storage unit comprises a spare storage unit, and wherein both the storage units maintain copies of the operating system and file system in the computer;
(iii) means for designating the second storage unit as the primary storage unit if the boot routine does not succeed, wherein the first storage unit is the spare storage unit after the second storage unit is designated as the primary storage unit; and
(iv) means for executing the boot routine from an operating system on the second storage unit designated as the primary storage unit after designating the second storage unit as the primary storage unit.

25. The network system of claim 24, wherein no user data that the hosts may request is maintained on the storage units in the servers.

26. An article of manufacture for operating a computer system including at least two storage units, wherein the article of manufacture causes operations to be performed, the operations comprising:
executing a boot routine from an operating system on a first storage unit of the at least two storage units designated as the primary storage unit, wherein a second storage unit of the at least two storage units comprises a spare storage unit, and wherein both the storage units maintain copies of the operating system and file system in the computer;
if the boot routine does not succeed, designating the second storage unit as the primary storage unit, wherein the first storage unit is the spare storage unit after the second storage unit is designated as the primary storage unit; and
after designating the second storage unit as the primary storage unit, executing the boot routine from an operating system on the second storage unit designated as the primary storage unit.

27. The article of manufacture of claim 26, further comprising:
performing a check operation on the spare storage unit; and
if the check operation fails, then copying the operating system and file system on the storage unit designated as the primary storage unit to the spare storage unit.

28. The article of manufacture of claim 27, wherein the check operation comprises checking the file system on the spare storage unit for inconsistencies.

29. The article of manufacture of claim 27, wherein the check operation comprises a series of check operations, wherein the copy operation is performed if one of the check operations fails.

30. The article of manufacture of claim 29, wherein a first check operation comprises checking the file system on the spare storage unit for inconsistencies and wherein a second check operation comprises mounting the file system on the spare storage unit.

31. The article of manufacture of claim 27, further comprising:
if the copy operation fails, transmitting an error message indicating an error on the spare storage unit.

32. The article of manufacture of claim 26, wherein performing the copying operation comprises mirroring the primary storage unit to the spare storage unit.

33. The article of manufacture of claim 32, further comprising:
modifying on the spare storage unit at least one of the files copied from the primary storage unit to the spare storage unit to indicate the file system on the spare storage unit.

34. The article of manufacture of claim 26, further comprising:
determining whether the spare storage unit includes a copy of the operating system; and
if the spare storage unit does not include the copy of the operating system, then copying the operating system and file system on the storage unit designated as the primary storage unit to the spare storage unit.

35. The article of manufacture of claim 34, wherein determining whether the spare storage unit does not include the operating system comprises determining whether the spare storage unit is empty.

36. The article of manufacture of claim 26, further comprising:
applying an upgrade to the operating system on the primary storage unit;
deleting data on the second storage unit as part of the upgrade to the operating system;
executing the boot routine after applying the upgrade; and
copying the operating system and file system on the storage unit designated as the primary storage unit to the spare storage unit during the boot routine executed after applying the upgrade.

37. The article of manufacture of claim 26, wherein the storage units comprise magnetic hard disk drives.

38. The article of manufacture of claim 26, wherein the storage units comprise separate partitions of a single hard disk drive.

39. The article of manufacture of claim 26, wherein no user data is maintained on the two storage unit drives.

40. The article of manufacture of claim 26, wherein designating one storage unit as the primary storage unit is performed by updating a parameter in a boot device in the computer.
